(19) United States
(12) Patent Application Publication
(10) Pub. No.: US 2006/0253833 A1
(43) Pub. Date: Nov. 9, 2006

(54) System and method for efficient hosting of wireless applications by encoding application component definitions

(75) Inventors: Vladimir Blagojevic, Manchester (GB); Kamen Vitanov, Mississauga (CA); Laura Doktorova, Mississauga (CA)

Correspondence Address: OGILVY RENAULT LLP, 1981 MCGILL COLLEGE AVENUE, SUITE 1600, MONTREAL, QC, H3A2Y3, CA

(73) Assignee: Research in Motion Limited, Waterloo (CA)

(21) Appl. No.: 11/358,065

(22) Filed: Feb. 22, 2006

Related U.S. Application Data
(60) Provisional application No. 60/672,085, filed on Apr. 18, 2005.

(51) Int. Cl. G06F 9/44

(52) U.S. Cl. 717/107

(57) ABSTRACT

A system and method for representing an application component of a component-based application. The application component is described by a component definition for referencing the application component at runtime. The component definition comprises at least one string. The system comprises a runtime environment for executing the component-based application. The runtime environment comprises computer-executable code for: accepting as input at least one component definition describing the application component; and defining a simplified data structure to represent the application component in which the at least one string is replaced with a respective unique value.

### FIELD OF THE APPLICATION

This application relates generally to wireless communications and wireless communications devices and, more specifically to a system and method for the efficient hosting of wireless applications by encoding application component definitions.

### BACKGROUND

The acceptance of wireless devices as a preferred personal communications medium has created a growing demand for such devices. Users of such devices also increasingly expect more functionality and a broader range of services to be made available through such devices. Not only is there a demand for more functionality, there is also a demand for faster response times and more efficient access to remote services.

A major challenge is faced in exposing wireless devices to complex data sources, such as Web services, due to the size and complexity of the data structures communicated from such sources. In wired networks and devices where resources and efficiency are not a significant concern, it is permissible to transmit, process and store large and complex data structures.

Complex data structures containing many objects and levels of nesting introduce a significant memory overhead on wireless devices. This impacts performance when storing to and retrieving from a memory store.

Consequently, what is desired is a method and apparatus to efficiently encode complex data structures of an application component definition.

### BRIEF DESCRIPTION OF THE DRAWINGS

FIG. 1 is a block diagram of a network system including wireless devices and a proxy in accordance with an embodiment of the application;

FIG. 2 is a schematic diagram illustrating a process for creating and enabling a system in accordance with an embodiment of the application;

FIG. 3 is a block diagram of a wireless device in accordance with an embodiment of the application;

FIG. 4 is a schematic representation of a representation of a complex data structure after it has been simplified using operations shown in FIG. 5;

FIG. 5 is a flowchart of operations in accordance with an embodiment of the application for reducing complex data structures in contiguous arrays;

FIG. 6 is a flowchart of operations in accordance with an embodiment of the application for encoding strings for storage in the reduced format arrays; and

FIG. 7 is a flowchart of operations in accordance with an embodiment of the application for resolving a string for use of the reduced format arrays during execution of a component-based application.

It will be noted that throughout the appended drawings, like features are identified by like reference numerals.

### DETAILED DESCRIPTION

The following detailed description of the embodiments of the present application does not limit their implementation to any particular computer programming language. The embodiments may be implemented in any computer programming language provided that the operating system provides the facilities that may support the requirements of the present application. A preferred embodiment is implemented in the Java™ computer programming language (or other computer programming languages such as C or C++). (Java and all Java-based trademarks are the trademarks of Sun Microsystems Corporation.) Any limitations presented would be a result of a particular type of operating system or computer programming language and would not be a limitation of the present application.

A system and method for the simplification of data structures, particularly those used for wireless communications, encodes data structures for efficient storage and access. Wireless devices are provisioned with user applications for accessing remote services, such as World Wide Web services. The user applications comprise a plurality of application component definitions which typically describe complex or hierarchical data structures including string-based references thereto for execution by a runtime environment. The runtime environment is conditioned to use a manner to encode such data structures in reduced format arrays or “flat” arrays of primitive data types, replacing such strings with unique values which strings may be resolved simply to their respective unique values to use the data structures during runtime.

In accordance with one aspect of the present application there is provided a system for representing an application component of a component-based application, the application component being described by a component definition for referencing the application component at runtime, the system comprising: a runtime environment for executing the component-based application, the runtime environment comprising computer-executable code for: accepting as input the component definition describing the application component, the component definition comprising at least one string; defining a simplified data structure to represent the application component in which the at least one string is replaced with a respective unique value.

Preferably, the computer-executable code uses the simplified data structure while executing the component-based application and when persisting the application component described by the component definition.

Preferably, the system further comprises computer-executable code for resolving the at least string at runtime to a respective unique value for using the simplified data structure representing the application component.

Preferably, the computer-executable code defines the simplified data structure as a plurality of arrays for storing structural description information, component field information, and objects comprising atomic elements described by the component definition.

Preferably, the computer-executable code defines a first array for storing the structural description information of the component definition.

Preferably, the computer-executable code defines a second array for storing the component field information.

Preferably, the computer-executable code defines a third array for storing the objects comprising atomic elements of the component definition.

Preferably, the computer-executable code replaces the at least one string of at least one the structural description information and component field information with a respective unique value.

Preferably, the computer-executable code associates the arrays to provide a reference-based relationship between the information stored in the arrays.

Preferably, the relationships are selected from the group consisting of: a component to its fields, a component to its objects, a field to its objects, and a field to its components.

In accordance with another aspect of the present application there is provided a method of representing an application component of a component-based application for execution on a data processing device, the application component being described by a component definition for referencing the application component at runtime, the component definition comprising at least one string, the method comprising: determining the at least one string of the component definition; and generating a unique value for the at least one string and storing the unique value in the simplified data structure.

Preferably, the step of generating a unique value comprises: generating a candidate unique value for the at least one string; when the candidate unique value is determined to be unique among previously generated candidate unique values for other strings, storing the candidate unique value as the unique value in the simplified data structure; when the candidate unique value is determined to be not unique among previously generated candidate unique values for other strings, generating a subsequent candidate unique value for the at least one string until the subsequent candidate unique value is determined to be unique, and storing the subsequent candidate unique value as the unique value in the simplified data structure.

Preferably, the method further comprises, when use of the at least one string is encountered during execution of the application component, resolving the at least one string to its respective unique value for using the simplified data structure representing the application component.

Preferably, the method further comprises obtaining the respective unique value for the string from a collision store defined in response to resolving collisions.

In accordance with a further aspect of the present application there is provided a memory for storing data for access by a runtime environment for a component-based application for execution on a data processing device, the component-based application comprising application components described by respective component definitions having hierarchical data structures, comprising: a data structure stored in the memory, the data structure comprising: a plurality of arrays for storing structural description information, component field information, and objects comprising atomic elements described by the component definitions, the arrays including references among the arrays to denote relationships between a component and any fields and objects described by the component definition, the arrays storing unique values to replace at least one string of any of the structural description information and component field information.

In accordance with further aspects of the present application there is provided an apparatus such as a data processing system, a method for adapting this system, as well as articles of manufacture such as a computer readable medium having program instructions recorded thereon for practising the method of the application.

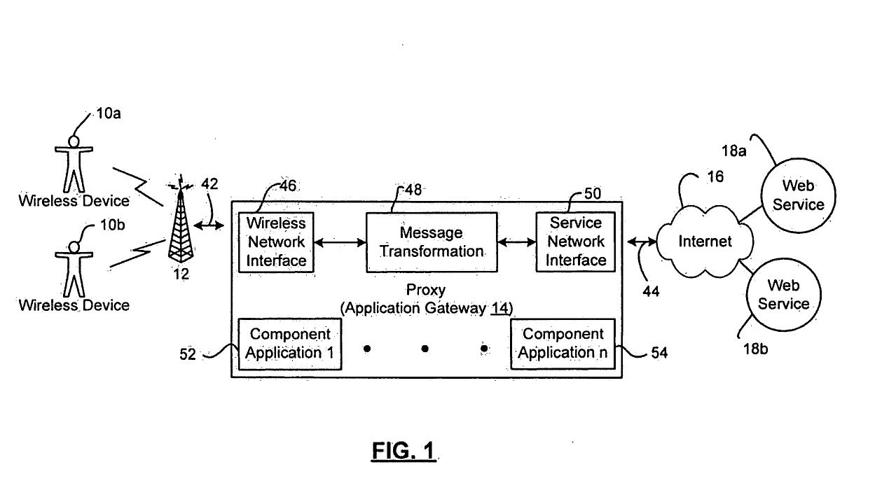

FIG. 1 is a block diagram of a network in which wireless devices 10a, 10b operate to send Web service request messages via a wireless network 12 to a stateful proxy which in one embodiment is an application gateway 14. The application gateway 14 forwards the Web service request messages through a service network such as the Internet 16 to an appropriate Web service 18a or 18b. The messages are processed by the appropriate Web service 18a or 18b and returned through the Internet 16 to the application gateway 14. The wireless network 12 forwards the response messages to the wireless device 10a, 10b which processes the response and displays, as applicable, response content to the wireless devices 10a, 10b.

The application gateway 14 supports a wireless network interface 46 having a link 42 to the wireless network 12. A message transformation function 48 receives messages from the wireless network interface 46 and processes the messages before forwarding the messages to a service network interface 50. The service network interface 50 has a link 44 to the service network 16 (the Internet, for example) over which it forwards the messages to an appropriate Web service(s).

In accordance with an embodiment of the application, the application gateway 14 is provisioned with a plurality of component-based applications 52, 54 which configure the application gateway 14 for processing the various messages. The application gateway 14 may also provision the wireless devices 10a and 10b with portions of the component-based applications 52, 54 to enable the devices 10a and 10b to access the Web services 18a and 18b via the application gateway 14.

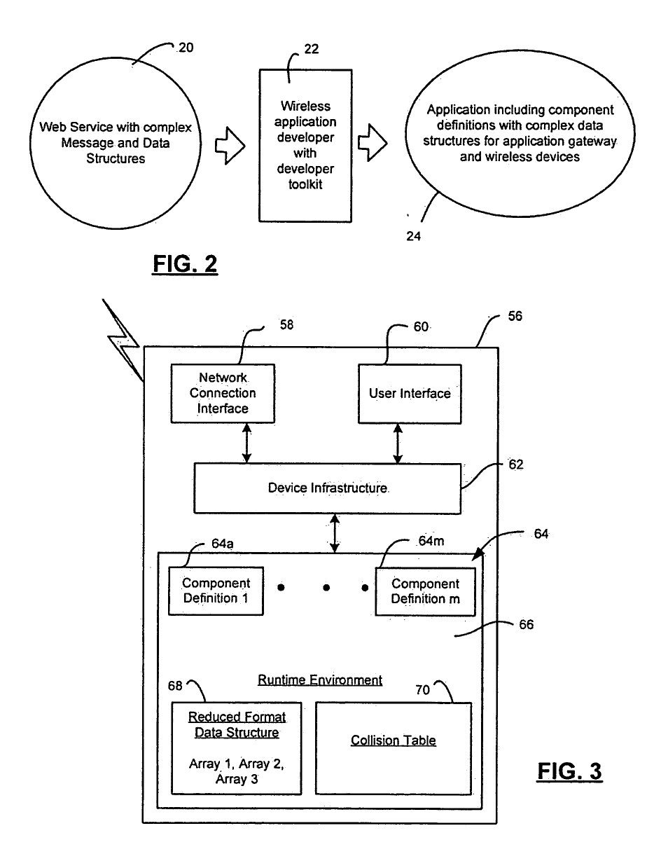

With reference to FIG. 2, a wireless application developer 22 uses a specification of a Web service 20 and an application developer toolkit to create component-based applications 24 (of which component applications 52 and 54 are examples) including application component definitions, mappings, and other artifacts for enabling a system in accordance with an embodiment of the application. The component-based applications 24 are used by the application gateway 14 and the wireless devices 10a and 10b to make and process service request and service response messages. For example, mappings from component-based applications 24 may comprise message mappings for the application gateway 14 that define a relationship in content between messages over the link 42 to the wireless network 12 and messages over the link 44 to the service network 16. Component definitions from the component-based application 24 may define various types of components for configuring the operations of wireless devices 10a and 10b including, but not limited to data, user interface, control, message and function components. Such definitions are typically expressed in a structured definition language such as eXtensible Mark-up Language (XML).

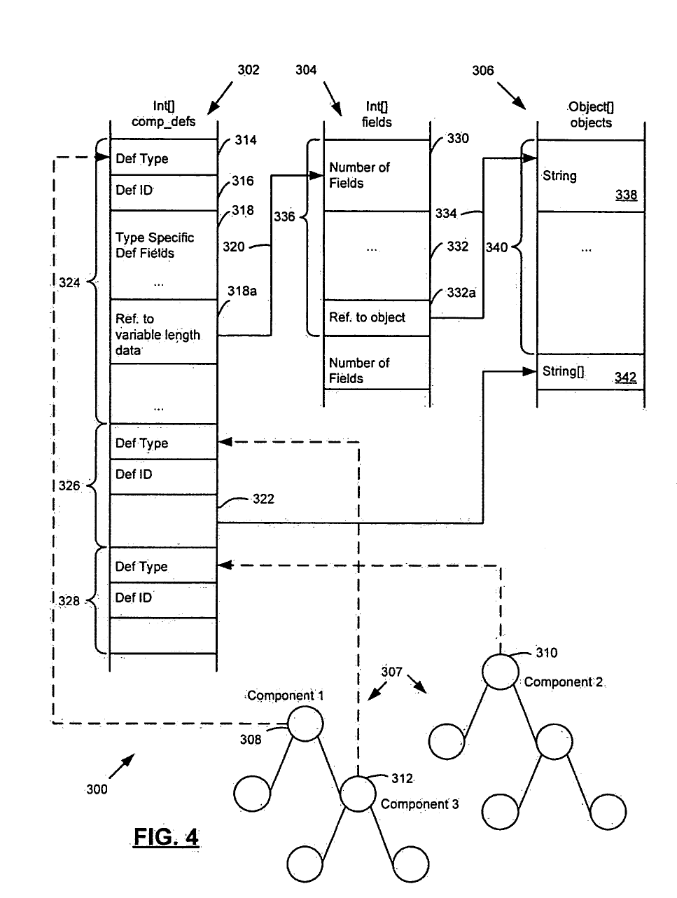

FIG. 3 is a block diagram of a wireless device 56 in accordance with an embodiment of the application. The wireless device 56 includes a network connection interface 58 used to communicate wirelessly with the public wireless carrier 12. The wireless device 56 further includes a user interface 60, which may be a keypad, a touch sensitive screen, voice recognition software, or any other user interface for wireless devices. A device infrastructure 62 includes memory, processor(s), peripheral ports, keypad, display and other hardware components required to support the functionality of the wireless device 56.

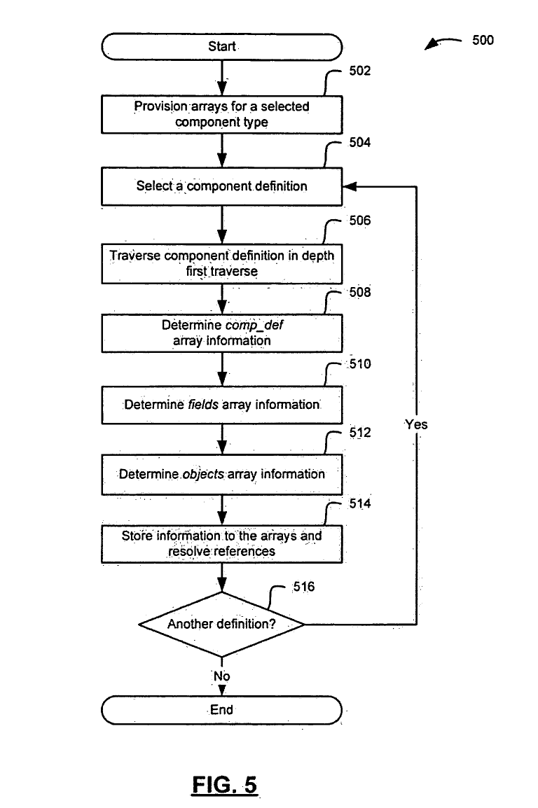

A runtime environment 66 provides basic resources and services and executes applications defined by the component definitions 64, represented individually by references 64a, . . . 64m, and other artifacts. The runtime environment may be configured as an intelligent container. The component definitions 64 typically use complex or hierarchical data structures containing many objects and levels of nesting. Processing these structures in a wireless device can entail significant memory and processing resources which may impact on the user experience. In accordance with an embodiment of the application, as will be explained below with reference to FIG. 5, the runtime environment 66 simplifies the hierarchical data structures by reducing or “flattening” into arrays of primitive data types. These types may include byte, int, long, string and other types for Java, C, C++ or similar programming languages.

FIG. 4 is a schematic representation of arrays 300 for providing a runtime implementation of hierarchal data structures 307. The arrays 300 comprise a first array 302 of primitive data type integer (int), a second array 304 of primitive data type int, and a third array 306 of type objects. By using these three arrays 302, 304 and 306, any hierarchical data structure can be represented in a reduced format or flattened and reference-based fashion to facilitate a more compact runtime representation than the traditional object-based component definition runtime representation. Arrays 302 and 304 are shown as integer types, however as will be appreciated by persons of ordinary skill in the art, the minimum size of entry is not necessarily the size of integer in the system (for example, on many systems 32 bits (4 bytes) are used to the type integer). For example, in some embodiments a byte may be used to represent a set of properties of a component type.

The first array 302 comp_defs provides the structural description of application components which contains the following information for each application component:

DefType: One of the common properties of the component definition representation is the DefType 314, which represents the type of the component. As noted earlier, various component types may be defined for the runtime environment and the types of components usually include, but are not limited to, Data, UI Control, Message and Functions. The portion of array 302 utilized to represent a size of a definition (indicated by reference 324 for “component 1” 308, by 326 for “component 2” 310, and by 328 for “component 3” 312) for different types are likely different, for each component type would likely have its own specific definition fields (i.e. TypeSpecificDefFields 318).

DefID: Another of the common properties of the component definition representation is the DefID 316 which represents the ID of the component. DefType and DefID together identify a definition of the component, i.e., a particular DefID itself cannot identify a definition among all types of component definitions, but its value should be unique in the group of component definitions that have the same definition type.

TypeSpecificDefFields: These fields 318 are used to identify the specific features of a definition of a specific component type. For example though not shown, a Data component of an application could have a field (integer or byte) to indicate if a data definition has a primary key and, if it has, the index of that primary key field of data. Another example, which is shown in FIG. 4, is a definition field 318a which contains an index that refers to the fields array 304 where fields are defined. Definition field 318a may indicate that the data component does not have any data fields with a value of −1.

It is noted that all component definitions having the same DefType are represented by the same portion of comp_defs array 302.

The second array 304, or fields describes the properties of component fields, such as number of fields 330, field type that can be either a primitive data type or data component, runtime properties of field such as if it has default value. For example property 332 references a default value using a pointer to objects array 306. Again, different types of components would have different properties and therefore, the amount of bytes of fields array 304 taken by this portion of a definition may differ.

The third array 306, or objects provides a place to store external objects that are taken as atomic elements in a component definition. For example, a String object 338, 342 that is referred to by a component definition (e.g. 308) as a default value of a field could be stored in the objects array 306. In summary, a hierarchical component definition is reduced or flattened into three compact arrays: e.g. two integer-type arrays and one object array. One type of component definition (e.g. Data) would have its own separate set of these three arrays from another type of component definition (e.g. Message). By doing this, runtime memory used by component definition representation is dramatically decreased.

FIG. 5 illustrates a flowchart of operations 500 in accordance with an embodiment of the application and embodied in computer-executable code for a runtime environment to simplify a complex data structure definition, reducing or flattening the structure into three arrays (e.g. 302-306) as discussed. The operations 500 for reducing or flattening component definitions of a single selected component type (e.g. data) are illustrated. In the first step 502, instances of the three arrays 302-306 are provisioned. Next, at step 504 a specific data component definition is selected. Next, at step 506 the component definition is traversed using a “depth-first” traversal and parsed to glean the required information. At steps 508, 510 and 512, information for each of the comp_def, fields and objects arrays 302-306 is determined. For example, a DefID 316 is generated for this instance of the particular DefType 314. TypeSpecificDefFields 318 are determined (including provisioning an index 318a to the fields array 304 for subsequent resolving as necessary). Particular field information 332 for the fields array is determined and a count of the number of fields 330 is determined. Objects (e.g. 338) are determined for the objects array 306. At step 514, the arrays 302-304 can be populated with the determined information and appropriate references resolved (e.g. the index from comp_def to fields, a particular field's default value reference index 332a to objects, etc.).

Sequential representation of a component definition within the arrays 302-306 means that the information for a subsequent definition is stored into the arrays 302-306 after all the information for the current definition is stored. At step 516, a determination is made as to whether another definition is available for simplifying. If so, the operations 500 loop to step 504. If not, the operations 500 end.

To further illustrate the storing of component definition information into the runtime representation (i.e. arrays 302-306), below is a portion of a sample component definition describing a data component with the name “Category” having a field with the field name “Title” of type string with a default value of “abcde”. Rather than storing the strings “Category” and “Title” in the reduced format (flattened) arrays, such strings may be advantageously stored in a space saving manner by encoding the same as integers:

<data name=“Category”>
<field name=“Title” defaultValue=“abcde”/>
</data>

Steps 508 and 510 may comprise operations to encode the respective comp_def and fields information.

FIG. 6 illustrates exemplary encoding operations 600 for generating a unique integer value (e.g. unique hash) for a given string. The encoding operations 600 are performed for all string instances prior to runtime, for example when the component-based application 52, 54 is installed or updated on a data processing system or device (e.g. the wireless device 56). The encoding operations 600 generate guaranteed unique integer values or identifiers (IDs) for all string instances for use of a simplified data structure or array 300 described above.

In a first step 602, a candidate unique integer is generated. Next, in step 604 the uniqueness of the candidate unique integer among previously generated integers for previously encoded strings is determined by comparing the candidate unique integer with integers in a “used-code” table (not shown). It will be appreciated that there are more possible strings to represent than the count of values that an integer type (typically 232) may represent. Thus, a hash or other function associating strings to integers will result in duplicate associations or “collisions” when two string instances comprising different characters initially map to the same integer encoding. In one embodiment, a commonly available hash function may be utilized to generate a candidate integer such as hashcode( ) for Java™ string types, for example. The used-code table is maintained to keep track of which hashes have been generated and to avoid duplicate associations. The used-code table is a temporary store for previously generated candidate integers generated during the encoding operations 600 prior to runtime and may be discarded after the encoding operations 600 end. The used-code table may be, for example, a bit vector or other structure, and is typically small in size or empty (i.e. if no collisions have occurred).

If the candidate unique integer is unique among previously generated integers for other string instances (i.e. if there is no collision), then operations proceed to step 610 where a guaranteed unique integer is returned.

If the candidate unique integer is not unique among previously generated integers for other string instances (i.e. if there is a collision), then operations proceed to step 606 where resolving operations are performed to resolve the collision and generate a guaranteed unique integer. When a collision occurs between a candidate unique integer and previously generated integer(s) stored in the used-code table, the collision is resolved according to a suitable collision resolving technique, for example, by incrementing the colliding candidate unique integer or generating a random number to generate a new candidate unique integer.

Reference will now be made to an exemplary string “Oakville” for encoding to illustrate an exemplary collision resolving technique in which collisions are resolved by incrementing the candidate unique integer until a guaranteed unique integer is obtained. If during the encoding of the string “Oakville” a candidate unique integer of 500 is generated, and it is determined that the integer 500 was previously used (as is determined by performing a look-up on the used-code table), then the candidate unique integer is incremented by one to generate a subsequent candidate unique integer 501 (it will be appreciated that other increments may be used). If the subsequent candidate unique was 501 previously used, a further subsequent candidate unique will be generated until a guaranteed unique integer is obtained. It will be appreciated that in other embodiments, if the further subsequent candidate unique integers are required, these values may be generated by the same or different collision resolution techniques as previous subsequent candidate unique integers. Because the actual number of stings to be hashed is much less than the number of integers available for hashing, eventual resolution of the collision is always possible. Advantageously, few collisions will typically occur and so only a small collision data structure needs to be maintained for keeping track of collisions and the unique integers assigned to a colliding string. Thus, string values from an application component definition can be encoded and stored for internal runtime representation, e.g. by an interpreter (not shown) for the runtime environment 66 as a unique integer. Typically, if a collision occurs the first subsequent candidate unique integer will result in a guaranteed unique integer.

Next, in step 608, after guaranteed candidate unique integer has been obtained it is stored in a collision table 70. The operations 600 then proceed to step 612 where the guaranteed unique integer is returned. As described above, it will be appreciated by persons skilled in the art that the hash or other function associating strings to integers implemented by the encoding operations 600 will generate the same unique integer or ID for each string, however the association function or operation cannot guarantee that this number is unique, i.e. collisions may occur. The collision table 70 allows collisions to be resolved to obtain a guaranteed unique integer, and provides a minimal data structure allowing the corresponding string and unique integer to be correlated for a colliding string during execution of the component-based application 52, 54 on the data processing system (e.g. the wireless device 56).

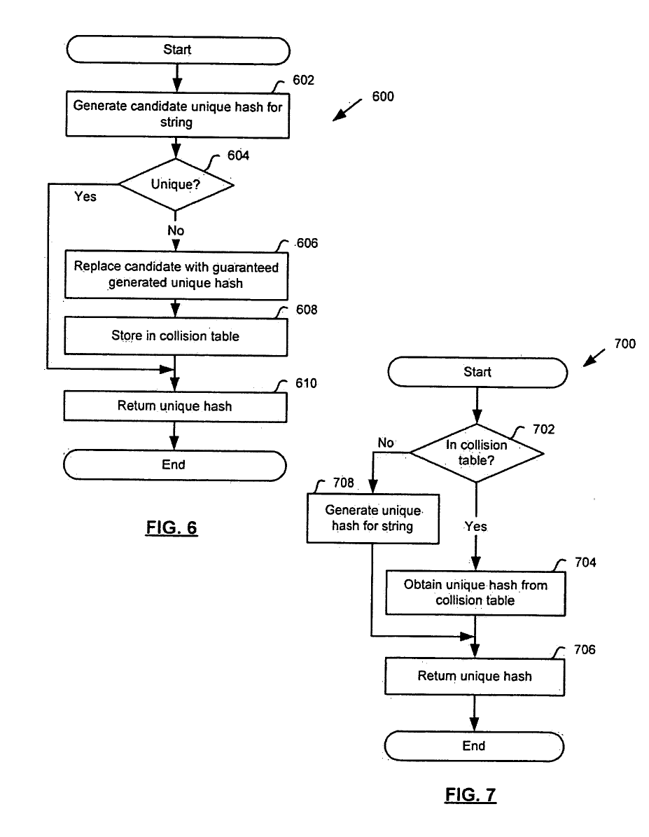

FIG. 7 illustrates operations 700 of an exemplary solution for resolving a given string to its corresponding unique integer (e.g. unique hash). The operations 700 are performed during execution of the component-based application 52, 54 on the data processing system (e.g. the wireless device 56). In the first step 702, the collision table 70 is checked for the string using a look-up or similar function. If the string is in the collision table 70 (i.e. if a collision occurred during encoding of the string), then the unique integer in the collision table corresponds to the string (e.g. 501 for “Oakville”). Operations 700 then proceed to step 706 where the unique integer is returned.

If the string is not in the collision table 70 (i.e. if no collision occurred during encoding of the string), then the unique integer for the string is the candidate unique integer generated in step 602 (e.g. 500 for “Oakville”) and the hash or other function associating strings to integers implemented by the encoding operations 600 is used to obtain the unique integer corresponding to the string. The operations 700 then proceed to step 706 where the unique integer is returned.

Although FIG. 7 illustrates an exemplary solution for resolving a given string to its corresponding unique integer, it will be appreciated by persons skilled in the art that the method of the present application may be adapted to resolve a given unique integer to its corresponding string during execution of the component-based application 52, 54 depending on the requirements of the component-based application 52, 54. Accordingly, when a component-based application 52, 54 receives data containing a string from a Web service 18a or 18b, the string value may be resolved to its respective unique integer.

References or relationships within a component definition are represented in the reduced format array or flat array structure 300. The aggregation or “has” relationship within one component definition (e.g. one component has 3 fields, a, b and c) is represented as a reference-based relationship between the three arrays 302, 304 and 306. There are four kinds of reference-based relationships between the information stored in the arrays 300: a component to its fields; a component to its objects; a field to its objects; and a field to its components. The types of reference-based relationships will now be described in further detail with reference to the above-described examples:

comp_defs-to-fields: A component is composed of fields. A field definition is represented infields array 304; to refer to the definitions of fields that the component has, comp_def array 302 keeps an index 320 at an entry 318a of the array 302 to the fields array 304 where its field definitions start (e.g. 330). For example, a data component A has 6 fields; the definition for each field takes 3 integers.

comp_defs-to-objects: comp_defs 302 can also refer to objects 306. For example, to represent an enumeration data type “Color”, which defines three enumeration values, “Red”, “Green”, “Blue” the high level description of “Color” (e.g. Component 3 in FIG. 4) is placed in comp_defs 322, then its possible values (field values) in objects 306 as a String[ ] object 342.

fields-to-objects: A field of a component could have a default value—in this case, the field definition (e.g. 332a) in fields 304 may just contain an index 334 to the default value 338 in objects array 306.

fields-to-comp: A field could be of type data component—in this case the file definition infields would contain the DefID of that data component, which can be used to uniquely identify that data component's definition (example not shown).

The reduced format or flat array structure proposed may be useful both during runtime for executing the application and for persisting data in accordance with the data structures defined by the component definitions. As will be appreciated by those skilled in the art, the embodiments described by the application allow application developers to improve wireless device performance by reducing data processing overheads. It also allows application developers to reduce storage space requirements on the wireless devices 10a, 10b by reducing space-consuming complex data structures.

Although the present application has been explained with reference to Web services, those skilled in the art will appreciate that the present application can be used to efficiently access any remote data source or service. While this invention is primarily discussed as a method, a person of ordinary skill in the art will understand that the data processing device discussed above with reference to wireless devices 10a, 10b and a wireless device 56, may be programmed to enable the practice of the method of the invention. Moreover, an article of manufacture for use with the wireless devices 10a, 10b or the wireless device 56, such as a pre-recorded storage device or other similar computer readable medium including program instructions recorded thereon, may direct the wireless devices 10a, 10b or the wireless device 56 to facilitate the practice of the method of the invention. It is understood that such apparatus and articles of manufacture also come within the scope of the invention.

The embodiments of the application described above are intended to be examples only. Those of skill in the art may effect alterations, modifications and variations to the particular embodiments without departing from the scope of the application. The subject matter described herein in the recited claims intends to cover and embrace all suitable changes in technology.

A portion of the disclosure of this patent document contains material which is subject to copyright protection. The copyright owner has no objection to the reproduction by any one of the patent document or patent disclosure, as it appears in the respective Patent and Trademark Office patent file or records, but otherwise reserves all copyrights whatsoever.

1. A system for representing an application component of a component-based application, the application component being described by a component definition for referencing the application component at runtime, the system comprising:
a runtime environment for executing the component-based application, the runtime environment comprising computer-executable code for:
accepting as input the component definition describing the application component, the component definition comprising at least one string;
defining a simplified data structure to represent the application component in which the at least one string is replaced with a respective unique value.

2. The system as claimed in claim 1, wherein the computer-executable code uses the simplified data structure while executing the component-based application and when persisting the application component described by the component definition.

3. The system as claimed in claim 1, further comprising computer-executable code for resolving the at least string at runtime to a respective unique value for using the simplified data structure representing the application component.

4. The system as claimed in claim 1, wherein the computer-executable code defines the simplified data structure as a plurality of arrays for storing structural description information, component field information, and objects comprising atomic elements described by the component definition.

5. The system as claimed in claim 4, wherein the computer-executable code defines a first array for storing the structural description information of the component definition.

6. The system as claimed in claim 5, wherein the computer-executable code defines a second array for storing the component field information.

7. The system as claimed in claim 6, wherein the computer-executable code defines a third array for storing the objects comprising atomic elements of the component definition.

8. The system as claimed in claim 4, wherein the computer-executable code replaces the at least one string of at least one of the structural description information and the component field information with a respective unique value.

9. The system as claimed in claim 4, wherein the computer-executable code associates the arrays to provide a reference-based relationship between the information stored in the arrays.

10. The system as claimed in claim 9, wherein the relationships are selected from the group consisting of: a component to its fields, a component to its objects, a field to its objects, and a field to its components.

11. A method of representing an application component of a component-based application for execution on a data processing device, the application component being described by a component definition for referencing the application component at runtime, the component definition comprising at least one string, the method comprising:
determining the at least one string of the component definition; and
generating a unique value for the at least one string and storing the unique value in the simplified data structure.

12. The method as claimed in claim 11, wherein the step of generating a unique value comprises:
generating a candidate unique value for the at least one string;
when the candidate unique value is determined to be unique among previously generated candidate unique values for other strings, storing the candidate unique value as the unique value in the simplified data structure;
when the candidate unique value is determined to be not unique among previously generated candidate unique values for other strings, generating a subsequent candidate unique value for the at least one string until the subsequent candidate unique value is determined to be unique, and storing the subsequent candidate unique value as the unique value in the simplified data structure.

13. The method as claimed in claim 11, further comprising, when use of the at least one string is encountered during execution of the application component, resolving the at least one string to its respective unique value for using the simplified data structure representing the application component.

14. The method as claimed in claim 13, further comprising obtaining the respective unique value for the string from a collision store defined in response to resolving collisions.

15. A memory for storing data for access by a runtime environment for a component-based application for execution on a data processing device, the component-based application comprising application components described by respective component definitions having hierarchical data structures, comprising:
a data structure stored in the memory, the data structure comprising:
a plurality of arrays for storing structural description information, component field information, and objects comprising atomic elements described by the component definitions, the arrays including references among the arrays to denote relationships between a component and any fields and objects described by the component definition, the arrays storing unique values to replace at least one string of any of the structural description information and component field information.
